(19) United States
(12) Patent Application Publication
(10) Pub. No.: US 2004/0075356 A1
(43) Pub. Date: Apr. 22, 2004

(54) Fan rotor

(75) Inventors: Alex Horng, Kaohsiung (TW); Yin-Rong Hong, Kaohsiung (TW); Ching-Sheng Hong, Kaohsiung (TW)

Correspondence Address: BACON & THOMAS, PLLC, 625 SLATERS LANE, FOURTH FLOOR, ALEXANDRIA, VA, 22314

(73) Assignee: SUNONWEALTH ELECTRIC MACHINE INDUSTRY CO., LTD., Kaohsiung (TW)

(21) Appl. No.: 10/270,550

(22) Filed: Oct. 16, 2002

(51) Int. Cl. H02K 21/26; H02K 23/04

(52) U.S. Cl. 310/154.08

(57) ABSTRACT

A fan rotor includes a tubular hub having a closed-end wall and an inner wall, with a metal ring receiving in the tubular hub in engagement with the inner wall. The metal ring has a magnet ring embedded therein. Furthermore, the tubular hub is provided with a plurality of retainers for releasably holding the metal ring in the tubular hub.

### BACKGROUND OF THE INVENTION

1. Field of the Invention

The present invention relates to a fan rotor and, more particularly, to a fan rotor in which a metal ring, a magnet ring and a tubular hub can be easily manufactured and in which the metal ring can be quickly fitted into the tubular hub.

2. Description of Related Art

As illustrated in FIG. 1, a conventional motor 90 for a fan typically includes a base 91 having a sleeve 92 which is surrounded by a stator 93 provided with windings. In the sleeve 92 there is a pair of bearings 94 rotatably support a shaft 96 of a rotor 95. The rotor 95 is integrally formed with a metal ring 97 and a magnet ring 98 both embedded therein.

It is known that the rotor 95 is made using an injection molding method in which the rings 97 and 98 are placed in a cavity of a related mold before injection of a melted material. However, the integrally combined rings 97 and 98 confine the molding process by producing one rotor 50 at a time, so as to ensure an acceptable precision in the dynamic balance of the resulting rotor 95. Therefore, the finished rotor 95 has relatively low productivity and is expensive in manufacture.

If two or more rotors 95 are molded simultaneously with a single mold, the different coefficient of thermal expansion of the rings 97 and 98 placed in the mold may result in variation upon different thermal conditions at parts of the mold and thus upon different flow rate of the melted material within respective cavities of the mold. Molding defects, such as cracks, then appear in the finished rotor 95, especially in an area adjacent to the rings 97 and 98. These rotors 95 usually have an unacceptable precision in dynamic balance thereof.

### OBJECTS OF THE INVENTION

The object of the present invention is to provide a fan rotor with a tubular hub, which is capable of being molded by plural cavities with the identical shape formed in a single mold and thus the finished tubular hub allows a combined metal ring and a magnet ring to be quickly fitted therein.

### SUMMARY OF THE INVENTION

The present invention provides a fan rotor comprising a tubular hub, a metal ring and a magnet ring embedded in the metal ring. The hub has a closed-end wall and an annular inner wall. The closed-end wall is formed with a axial seat through which a shaft extends, and the inner wall is used for tightly engaging with the metal ring. The fan rotor further comprises a plurality of retainers for holding the metal ring therein.

Other objects, advantages and novel features of this invention will become more apparent from the following detailed description when taken in conjunction with the accompanying drawings.

### BRIEF DESCRIPTION OF THE DRAWINGS

FIG. 1 is a cross-sectional view of a conventional motor for a fan;

FIG. 2 is an exploded perspective view of a first preferred embodiment of a fan rotor in accordance with the present invention;

FIG. 3 is a cross-sectional view of the fan rotor of FIG. 2;

FIG. 4 is a cross-sectional view taken along lines 4-4 in FIG. 3;

FIG. 5 is a cross-sectional view of a second preferred embodiment of the inventive fan rotor; and

FIG. 6 is an enlarged cross-sectional view taken from a part 6 in FIG. 5.

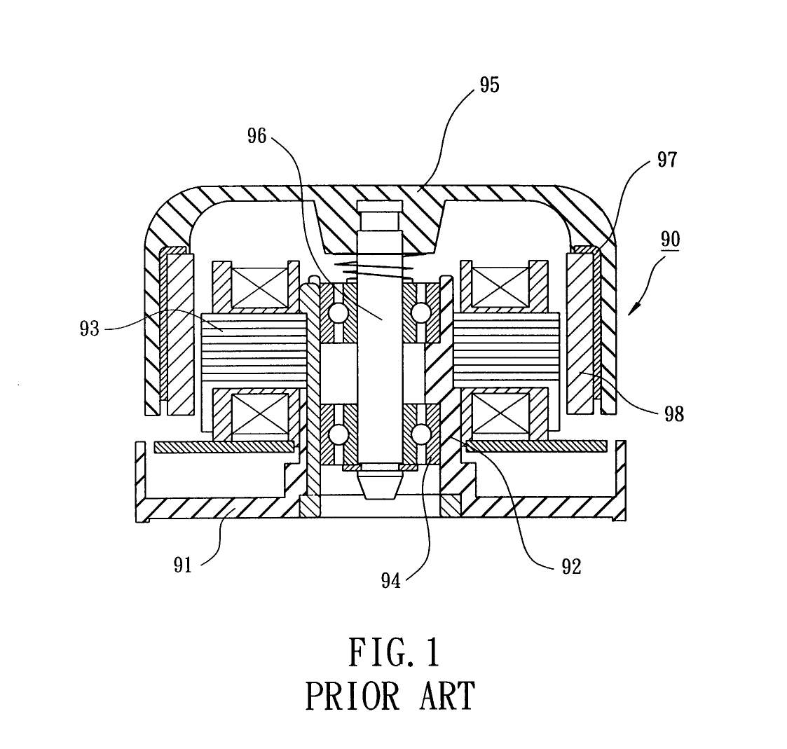

### DETAILED DESCRIPTION OF THE PREFERRED EMBODIMENT

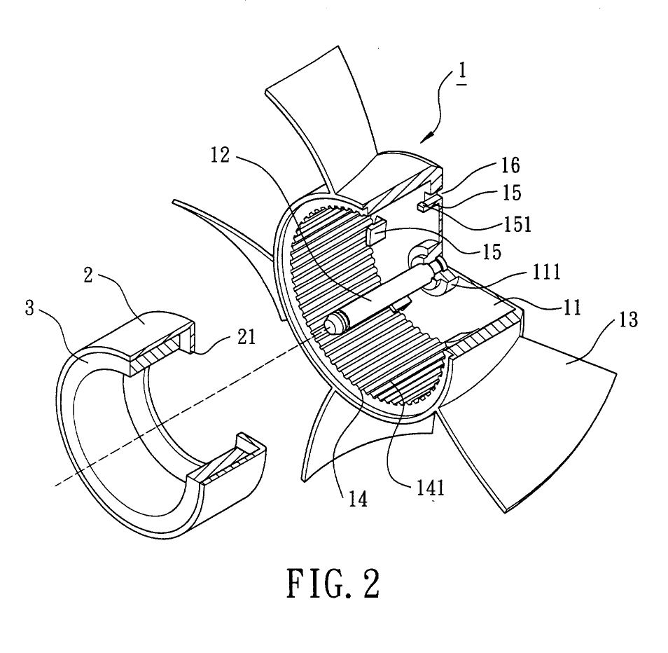

Referring to FIG. 2, there is shown a first preferred embodiment of a fan rotor in accordance with the present invention. The fan rotor includes a tubular hub 1 with a plurality of blades 13 extending radially outward therefrom, so as to be formed as an impeller wheel.

The tubular hub 1 has a closed-end wall 1 and an annular inner wall 14. The closed-end wall 11 is formed with a axial seat 111 from which a shaft 12 extends towards an open end of the hub 1. Furthermore, the inner wall 14 has a plurality of axial teeth 141, preferably provided in odd number, for engaging with a metal ring 2 which is received in the tubular hub 1.

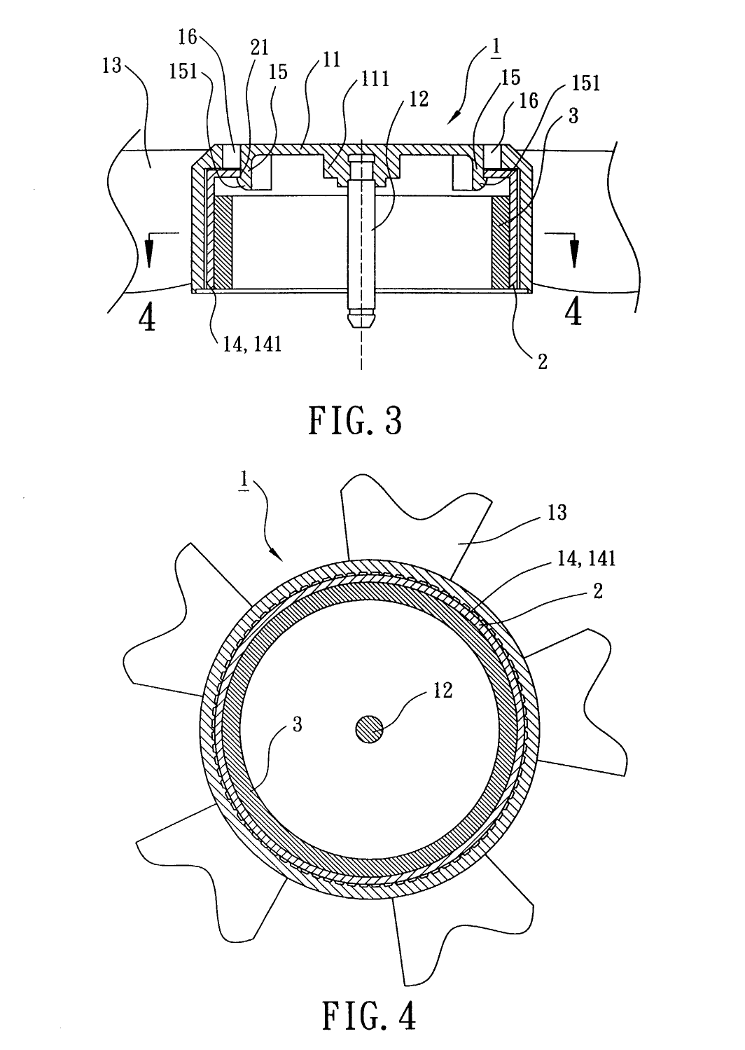

The metal ring 2 has an annular lip 21 at an end thereof adjacent to the closed-end wall 11 of the tubular hub 1, and is formed with a magnet ring 3 embedded therein. Particularly, the metal ring 2 has an external diameter slightly larger than a diameter of an imaginary cylindrical surface defined by tips of the axial teeth 141, thereby enabling the metal ring 2 to be tightly fitted in the tubular hub 1, as best seen in FIG. 4.

Referring to FIG. 3, the tubular hub 1 is further provided with a plurality of retainers 15, also arranged in odd number, that extend from the closed-end wall 11 of the hub 1. Each of the retainers 15 has a barb 151 adapted to snap over and engage with the annular lip 21, thus releasably holding the metal ring 2 as well as the magnet ring 3 in the tubular hub 1.

The metal ring 2 can be detached from the hub 1, such as by means of a stick that extends through apertures 16 defined in the closed-end wall 11 to disengage each barb 151 from the annular lip 21 of the metal ring 2. The ring 2 then can easily be pushed out of the hub 1 by the same stick.

Referring to FIG. 4, the metal ring 2 is placed into the tubular hub 1 after the magnet ring 3 has been embedded in it. As mentioned above, the metal ring 2 has an external diameter slightly larger than the diameter of an imaginary cylindrical surface defined by the tips of the axial teeth 141. This ensures that the ring 2 is fitted in the tubular hub 1 in tight engagement with the toothed inner wall 14.

This engagement becomes more secure when the axial teeth 141 are provided in odd number, since the metal ring 2 is then fitted in the tubular hub 1 in an asymmetrical manner.

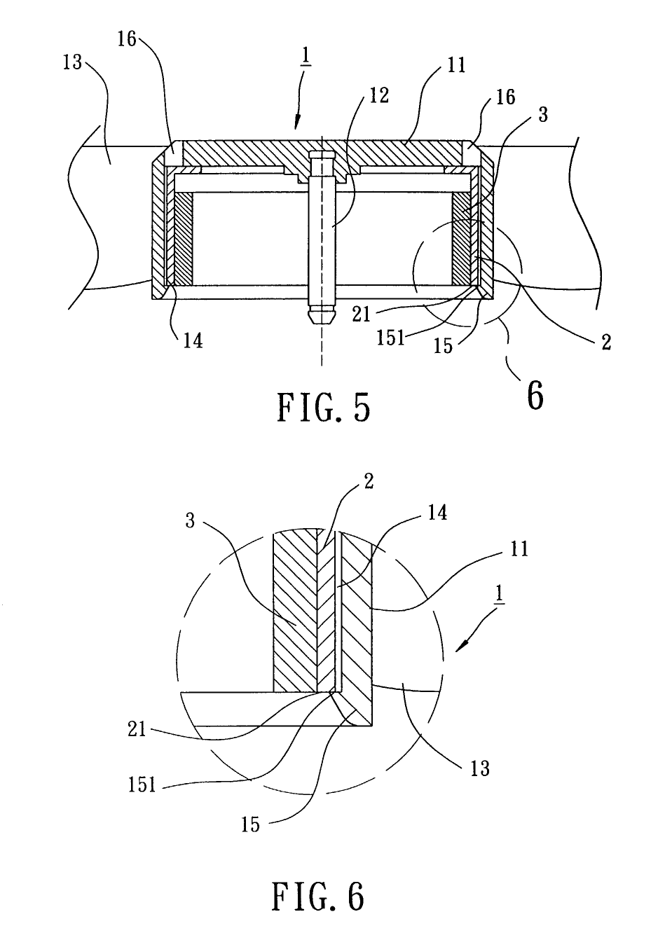

Referring to FIGS. 5 and 6, a second preferred embodiment of the inventive fan rotor is shown. This embodiment is substantially similar to the first one except that a plurality of retainers 15 extend from the open end of the tubular hub 1 but not from the closed-end wall 11. Each of the retainers 15 here has a barb 151 adapted to snap over and engage with an end 21 of the metal ring 2 opposite to the closed-end wall 11, as best shown in FIG. 6, thus releasably holding the metal ring 2 as well as the magnet ring 3 in the tubular hub 1.

From the foregoing, it is apparent that this invention has the advantage of enabling the tubular hub 1 to be molded to avoid placing the combined metal and magnet ring in a cavity of a related mold. Thus, two or more tubular hubs of such type can be molded simultaneously by plural cavities of the identical shape formed in a single mold. This results in a high productivity and a low cost in manufacture for the tubular hubs.

Furthermore, the tubular hub allows the combined metal and magnet ring to be fitted therein easily and quickly. The resulting fan rotors then have a uniform quality and an acceptable precision in their dynamic balance.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A fan rotor comprising:
a tubular hub having a closed-end wall and an inner wall; and
a metal ring being received in said tubular hub in engagement with said inner wall, said metal ring having a magnet ring embedded therein;
said tubular hub being provided with a plurality of retainers for releasably holding said metal ring in said tubular hub.

2. The fan rotor as claimed in claim 1, wherein said metal ring has an annular lip formed at an end thereof adjacent to said closed-end wall, and wherein said retainers extend from said closed-end wall and each have a barb adapted to snap over and engage with said annular lip, thereby releasably holding said metal ring in said tubular hub.

3. The fan rotor as claimed in claim 1, wherein said retainers extend from an open end of said tubular hub and each have a barb adapted to snap over and engage with an end of said ring opposite to said closed-end wall, thereby releasably holding said metal ring in said tubular hub.

4. The fan rotor as claimed in claim 1, wherein said inner wall of said tubular hub is formed with a plurality of axial teeth, and wherein said metal ring has an external diameter slightly larger than a diameter of an imaginary cylindrical surface defined by tips of said axial teeth, so as to enable said metal ring to be tightly fitted in said tubular hub.

5. The fan rotor as claimed in claim 1, wherein said closed-end wall of said tubular hub is formed with a axial seat, and wherein a shaft extends from said central seat.

6. The fan rotor as claimed in claim 1 further including a plurality of blades extending radially outward from said tubular hub, so as to be formed as an air impeller.

7. The fan rotor as claimed in claim 1, wherein said axial teeth are arranged in odd number.

8. The fan rotor as claimed in claim 1, wherein said retainers are arranged in odd number.
